(19) United States
(12) Patent Application Publication
(10) Pub. No.: US 2003/0158762 A1
(43) Pub. Date: Aug. 21, 2003

(54) System and method for airplane security / service / maintenance management

(76) Inventor: Jiang Wu, Fremont, CA (US)

Correspondence Address: DR. JIANG WU, 778 WASATCH DR., FREMONT, CA, 94536, US

(21) Appl. No.: 10/341,092

(22) Filed: Jan. 14, 2003

Related U.S. Application Data
(60) Provisional application No. 60/349,508, filed on Jan. 18, 2002.

(51) Int. Cl. G06F 17/60

(52) U.S. Cl. 705/5; 705/1

(57) ABSTRACT

A system and method provides overall security, service, and maintenance management for airlines. The system intends to reinforce national security by installing safeguard on-board computer system on every commercial airplane, maximize customer confidence and satisfaction by providing scalable security/service management, communicate with FAA, FBI, or CIA systems by using new telecommunication technology, and Interact with Apollo, Saber and other airline legacy systems by providing individualized interfaces. The system also helps flight attendants to have better passenger services, and helps mechanics to have better aircraft maintenance.

### PATENT CASE TEXT

This application claims the benefit of the U.S. Provisional Applications Serial No. 60/349,508, filed Jan. 18, 2002.

CROSS REFERENCE TO RELATED APPLICATIONS

| | | | |
|---|---|---|---|
| 6119096 | December, 2000 | Stewart et al. | 705/5. |
| 5991429 | November, 1999 | Coffin et al. | 382/118. |
| 5866888 | February, 1999 | Bravman et al. | 235/375 |

### STATEMENT REGARDING FEDERALLY SPONSORED RESEARCH OR DEVELOPMENT

Not applicable

### REFERENCE TO SEQUENCE LISTING, A TABLE, OR A COMPUTER PROGRAM LISTING COMPACT DISK APPENDIX

Not applicable

### BACKGROUND OF INVENTION

After Sep. 11, 2001, the security of airports and airplane has become an important issue. Many companies proposed and implemented various types of air travel security systems by using biometrics and other devices, and some companies tried to install control computers on the airplane.

However, there is no known company provides a product that utilizes a computer local area network on airplanes to handle all passenger security, service, and aircraft maintenance related problems, and no known company proposed an overall solution for security and service issues of the airline industry by integrating an airplane on-board computer system with legacy systems at airports, airline headquarters, FAA control centers, and FBI/CAI information systems.

Therefore, the inventor believes that there is a need for a system that uses new technologies to provide a fully integrated passenger security and service system for airlines, airports and FAA.

### BRIEF SUMMARY OF THE INVENTION

The general object of the invention is to provide a system and method to achieve overall airline passenger security and service management by integrating a new airplane on-board computer system with existing legacy systems in airline's/FAA's control centers, and airport check-in counters/security checkpoints.

Another object of the invention is to provide an airplane on-board computer system on every commercial airplane to provide air marshals, pilots and flight attendants with passenger security level checking and cabin real time monitoring abilities.

A more specific object of the invention is to provide an improved method for collecting passengers' information and assigning security ranking levels to improve passenger's background checking.

Another object of the invention is to provide a system that uses passengers' biometrics information for authentication check without the intrusion of passengers' privacy by using a smart card to store the biometrics information.

Yet another object of the invention is to provide a system that interacts with FBI and CIA's computer system when there is a need.

A very important object of the invention is to provide a telecommunication system for airline's control center and FAA control center to monitor an airplane's cabins on demand in real time.

Another object of the invention is to provide a system that uses touch screen panel PCs and palm PCs to simplify various operations on the airplane.

It is also an object of the invention is to provide an airplane on-board service management system for flight attendants to management seats, service items, and travel information.

Yet another object of the invention is to provide an airplane on-board aircraft maintenance management system for flight attendants and aircraft mechanics to record problems and solutions.

A further object of the invention is to provide a system that adopts an open architecture and has interfaces with products from different computer hardware, software, biometrics and telecommunication companies.

### BRIEF DESCRIPTION OF THE DRAWINGS

FIG. 1 System Architecture

FIG. 2 Airplane On-board System Configuration

FIG. 3 Airport Subsystem Check-in Counter Configuration

FIG. 4 Airport Subsystem Security Checkpoint Configuration

FIG. 5 Reservation Logic

FIG. 6 Ticketing Logic

FIG. 7 Check-in Logic

FIG. 8 Boarding Logic

FIG. 9 Airplane On-board System Main Screen

FIG. 10 Airplane Door Verification Screen

FIG. 11 Cabin Selection Screen

FIG. 12 Seat Occupancy Screen

FIG. 13 Passenger Information Screen

FIG. 14 Seat Security Ranking Screen

FIG. 15 Passenger Roster Screen

FIG. 16 Cabin Monitoring Screen

FIG. 17 Passenger Connection List Screen

FIG. 18 Flight Information Screen

FIG. 19 Pilot/Flight Attendant Information Screen

FIG. 20 Aircraft Maintenance Screen

### DETAIL DESCRIPTION OF THE PREFERRED EMBODIMENT

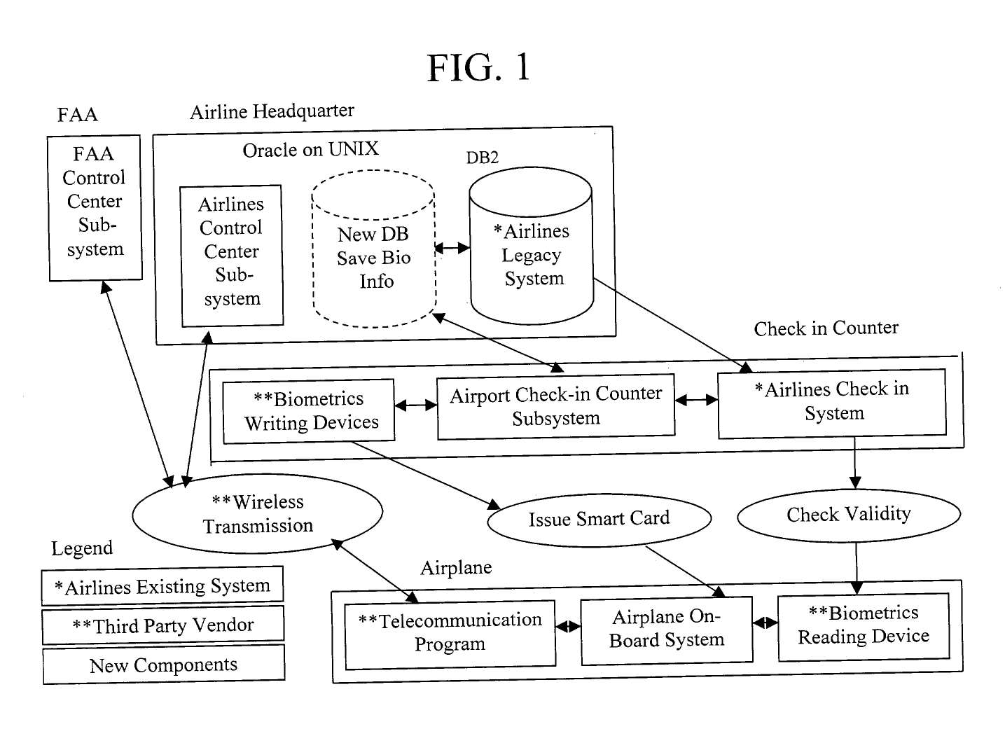

FIG. 1 shows the architecture of the system. The system has three major components: airplane on-board system, airport subsystem, and airlines/FAA control center subsystem. The airplane on-board system is a totally new developed system. The other two subsystems are add-on systems to existing legacy systems of different airlines, airports and FAA. The whole system provides open interfaces to different existing systems. FIG. 1 also shows relationships among the three components. At an airline's headquarter, a new database may be added to keep passengers' biometrics information, if the airline wants to have a centralized repository and passengers do not concern much about their privacy. Otherwise, all biometrics information will be saved into a smart card boarding pass, and the passenger holds the smart card boarding pass in his possession. In this case, the airlines/FAA control center subsystem only contains a telecommunication monitoring system to have an emergency interaction with the airplane on-board system on demand. The communication can be through a satellite or other means.

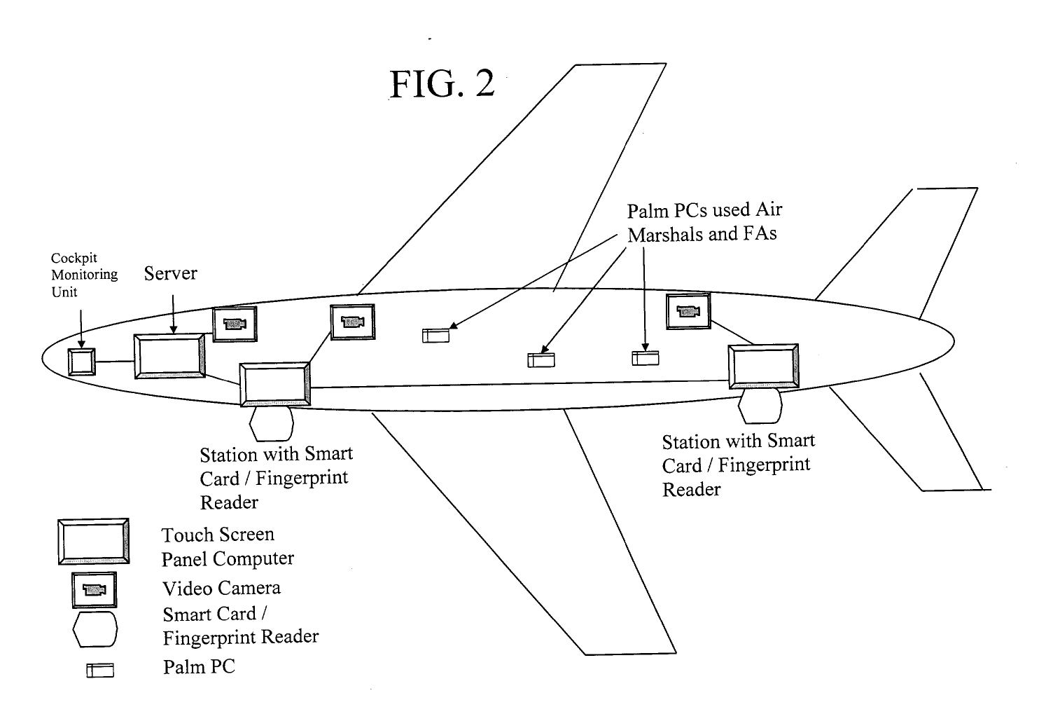

FIG. 2 shows the system configuration of the airplane on-board system, which contains a server and several stations. The server is a touch screen panel PC installed closed to the cockpit. A monitoring unit is connected to the server and is installed inside the cockpit. It is used for pilots to monitor cabins and the passenger status. In case of emergency, the server directly communicates with ground systems in airlines and FAA control centers. The server also maintains the database for the flight. Stations are either touch-screen panel PCs with pocket size printers, or hand held palm PCs. Panel PC stations are mounted either on the wall close to the door or in the service area. Panel PC stations close to the doors are equipped with biometrics devices that can verify the authentication of each boarding passenger. Panel PC stations in the service area or palm PCs are used to monitor passenger status and facilitate passenger services. Video cameras and microphones are connected to the server and panel PC stations, and are installed in all cabins.

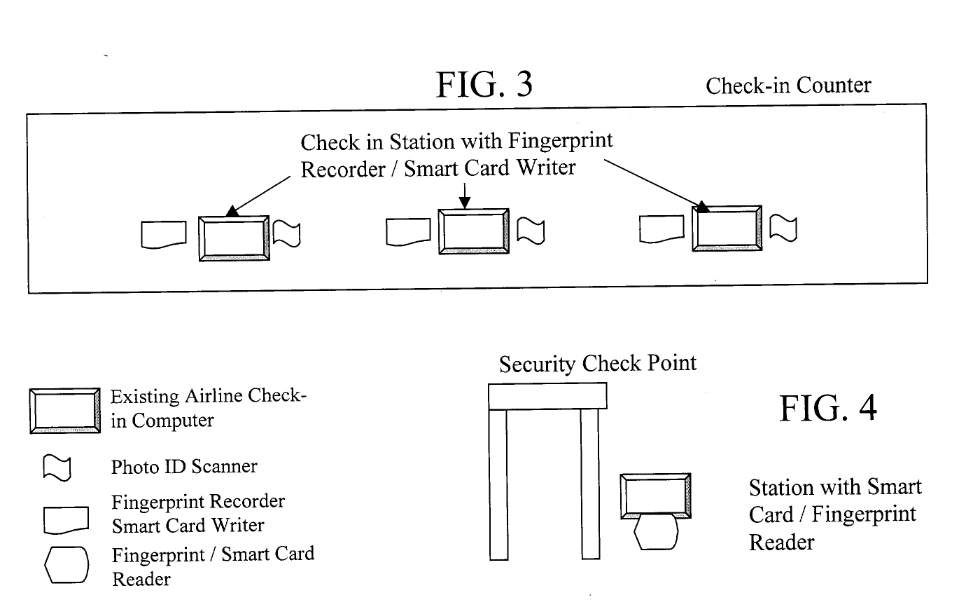

FIG. 3 shows the check-in components of the airport subsystem. This component is a computer software program installed on an existing airline check-in counter PC. The PC is connected to the airline's legacy check-in system, and is also connected to a biometrics/smart card writer combo unit and photo ID scanners.

FIG. 4 shows the security checkpoint component of the airport subsystem. Biometrics/smart card reader combo units are installed at security checkpoints. For the purpose of simplicity, we use fingerprint recognition as a sample of the biometrics technology. In fact, ASMS is able to have interfaces with different biometrics vendors using any hand geometry, iris, retina, finger scan, face scan, and other human features.

The system's functionality can be divided into three major categories:

anti-terrorist and security management

passenger services management

aircraft maintenance management.

The anti-terrorist and security management portion of the system includes four major functions:

Passenger information collecting and security level ranking

Biometrics/smart card boarding pass

Cabin video/audio information monitoring

Instant wireless communication of emergency information

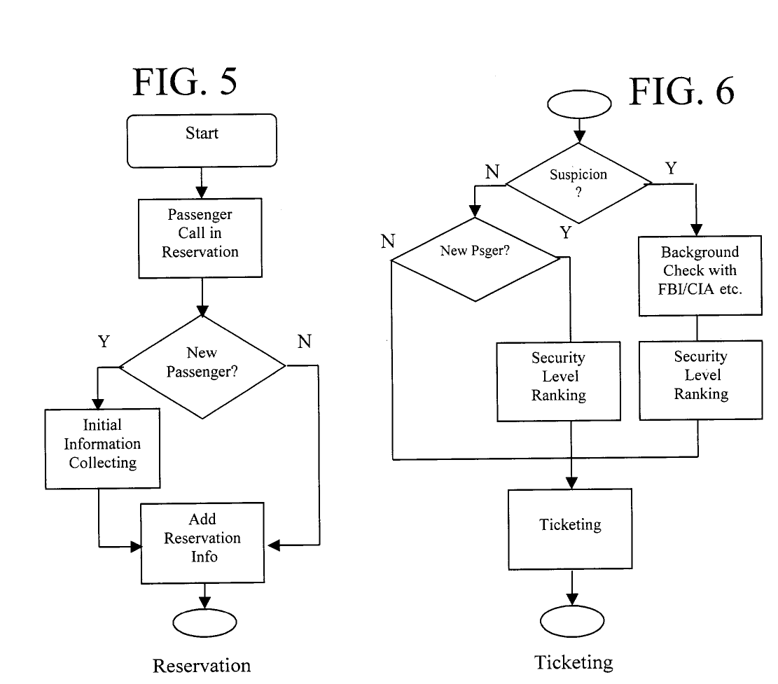

FIG. 5 shows the logic of the passenger reservation procedure. It is the first stage of passenger information collecting. When a passenger calls in to make a reservation, if he/she is a new passenger, the travel agent will collect his/her initial information and save the information into the airline's reservation system. If the airline uses an old legacy reservation system, the system probably needs to add new fields to keep security related information.

FIG. 6 shows the logic of the passenger ticking procedure. At the time of ticketing, the customer service representative (CSR) tries to detect any sign of suspicion. If no suspicion is found, for a new passenger, the CSR assigns him/her an initial level of security ranking. If the passenger causes some suspicion, the CSR makes further background check through connected FBI or CIA computer system, then assigns the passenger a higher level of security ranking.

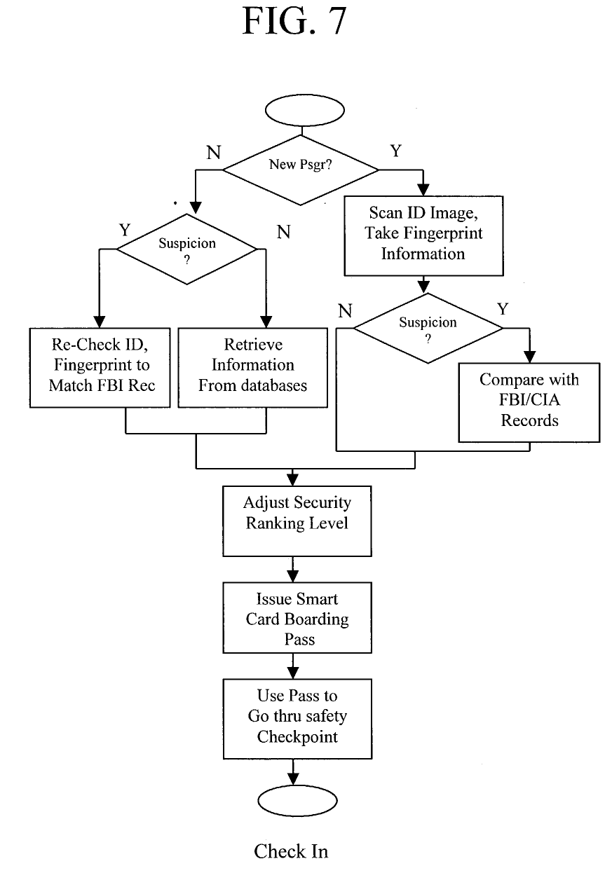

FIG. 7 shows the logic of the check-in procedure. At the check-in counter, for a new passenger, the CSR takes the passenger's biometrics information, and tries to detect any suspicion. If any suspicion is found, the CSR makes further background check through connected FBI or CIA computer system. For an old passenger, if no suspicion is detected, the CSR directly retrieves the passenger's information from the legacy database. If any suspicion is detected, the CSR needs re-check the passenger's ID and biometrics information trying to match FBI/CIA's record. When needed, the CSR re-adjusts the passenger's security level ranking, and then issues the passenger a smart card boarding pass. The biometrics/smart card boarding pass replaces the traditional paper boarding pass. Passenger's biometrics, general, and flight information are stored in the smart card. A passenger is allowed to pass the security checkpoint only if his biometrics feature matches the biometrics information stored in the smart card, and the flight data stored in the card is correct for the gate.

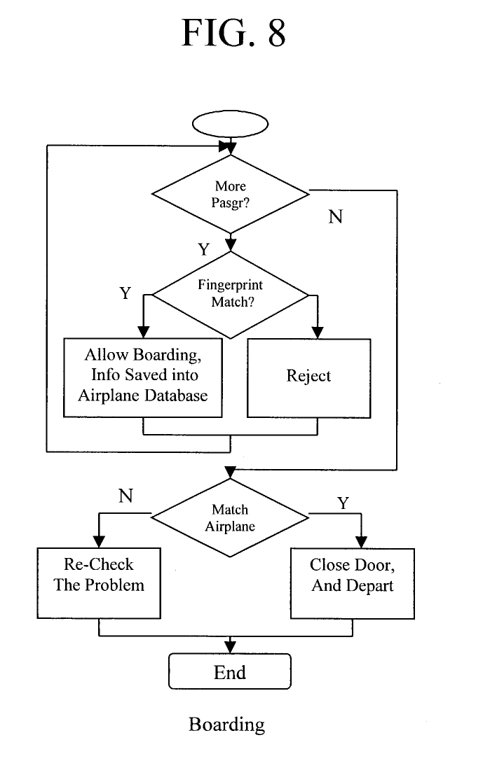

FIG. 8 shows the logic of the boarding procedure. A flight attendant uses a smart card/biometrics reading combo unit to match the biometrics information on the card with the fingerprint taken from the boarding passenger. If the passenger passes the match, and the flight information stored in the card is correct, he/she is allowed the boarding, and the passenger's information is saved into the database on the airplane on-board system. If the passenger fails the match, he/she is rejected, and is taken for further background checking. After all passengers are boarded, the airplane on-board system compares the boarding data with the check-in data sent from the front check-in counter (through wire or wireless communication). If they match, the flight attendant closes the airplane door and prepares for a departure. If they do not match, the flight attendant stops the procedure for further checking.

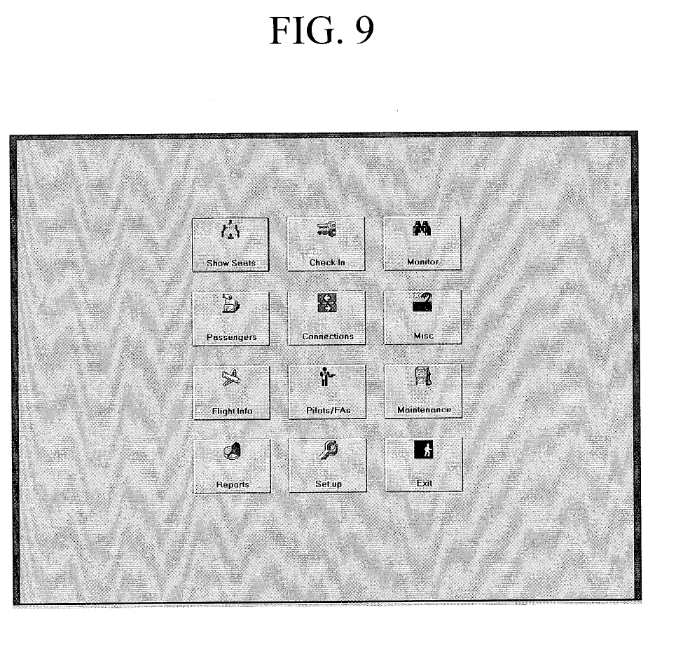

FIG. 9 shows the main screen of the airplane on-board system. Through the main screen, the flight attendant can access many passenger services functions. The system maintains passenger general information, airplane-specific information, flight-specific information, travel information, and weather information.

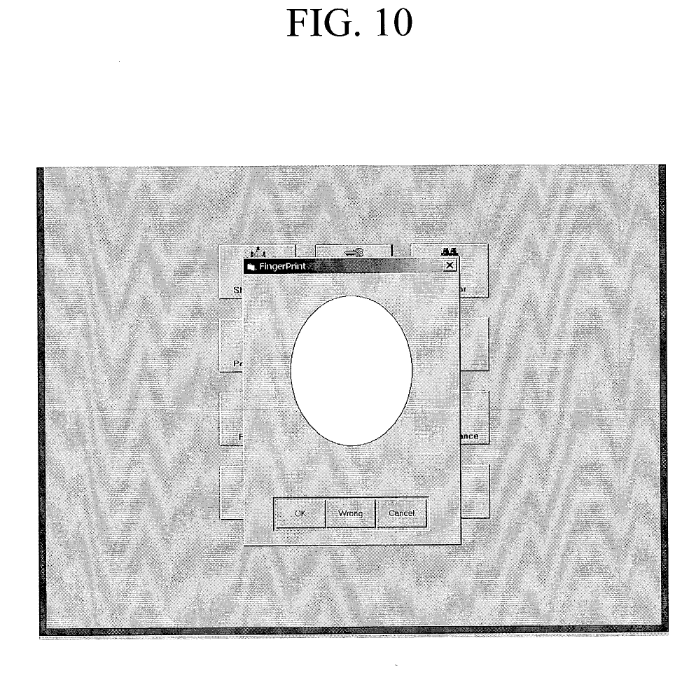

FIG. 10 shows an airplane door verification screen. When a passenger tries to enter the airplane door, a flight attendant opens this screen, lets the passenger insert the smart card into the biometrics/smart card reader unit, and asks the passenger provide a fingerprint on the unit. If accepted, the passenger is allowed to board the airplane.

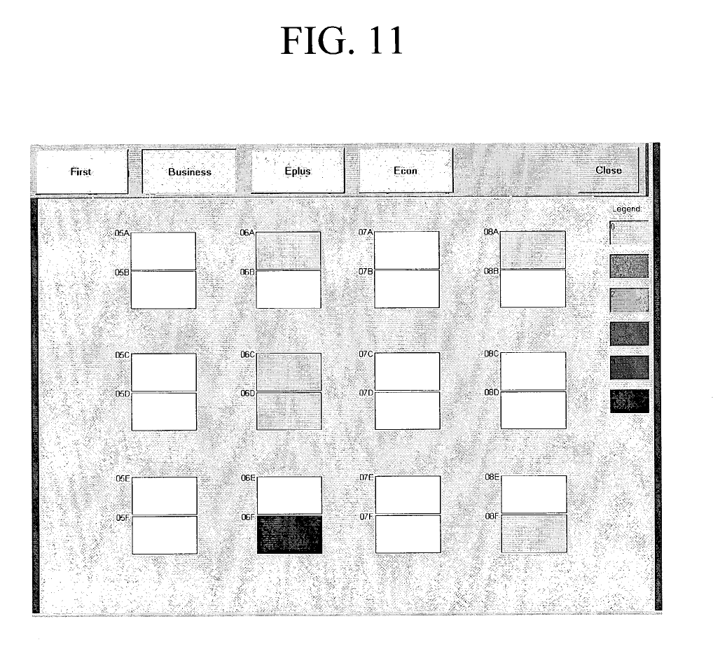

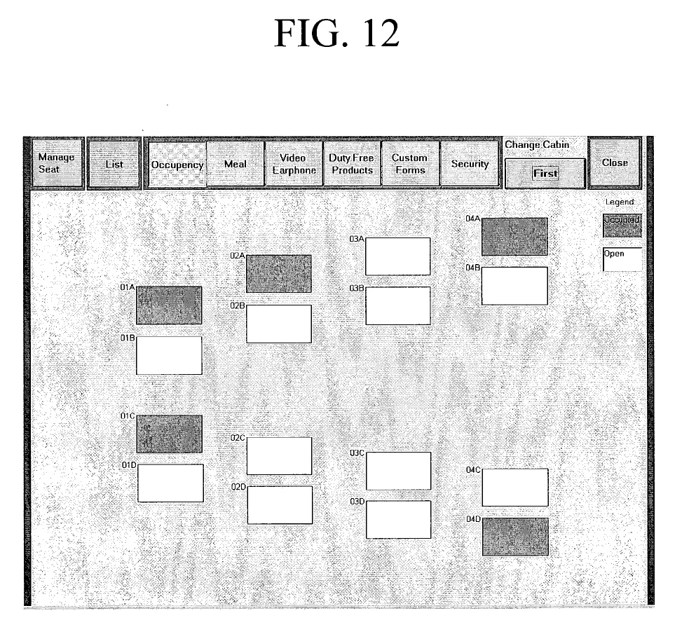

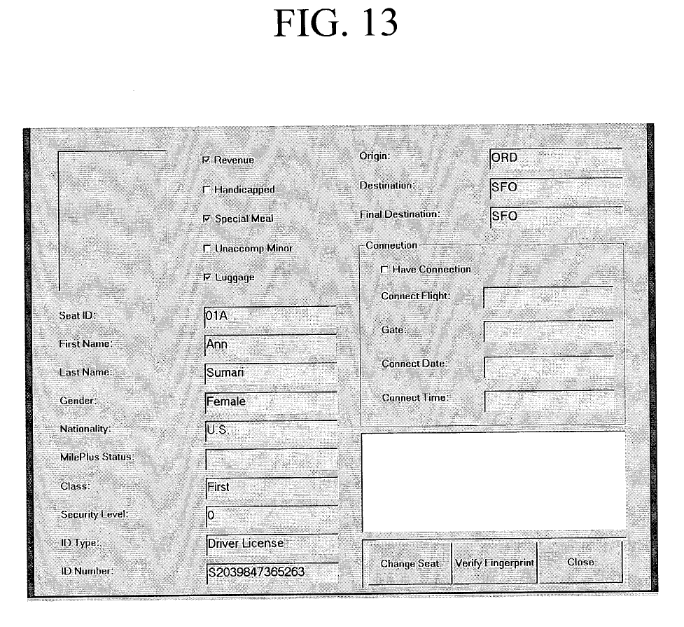

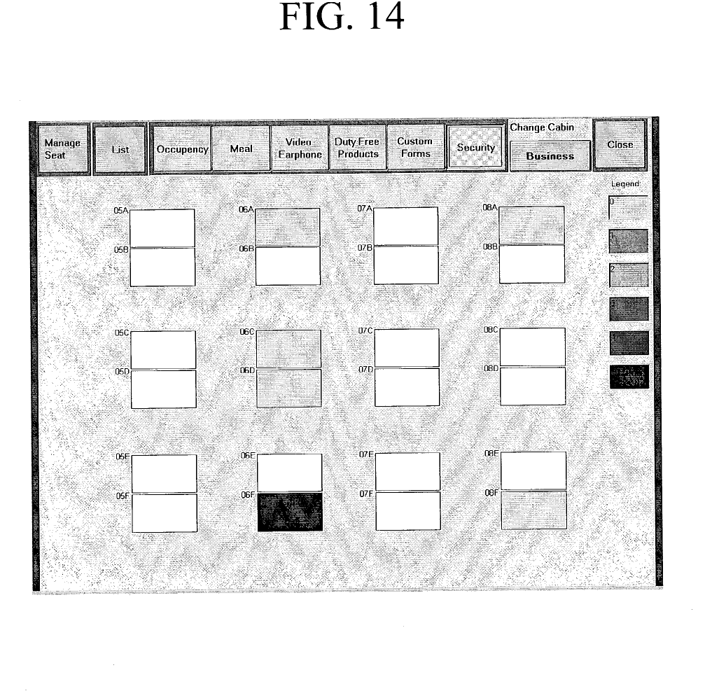

FIG. 11 shows a cabin selection screen for flight attendants to select a floor map for the cabin. FIG. 12 shows a seat occupancy map for the target cabin on the airplane. FIG. 13 shows a passenger general information screen, which is invoked by selecting a seat on the screen of FIG. 12. The passenger's general information contains many details such as a passenger's name, age, itinerary, handicapped status, etc. In addition to the occupancy map, the status of food ordering, earphone/video renting, duty-free products purchasing, custom forms delivery, and security level ranking can be displayed on the floor map when selected. The passenger's information and other information can be accessed from the floor map screen easily. Routine service modules of the system improve the service quality of the airlines to passengers. Routine services include many functions. Meals can be ordered through a handheld palm PC. After a meal is served, the flight attendant marks the order as fulfilled, thus reduces the possibility of errors. VCR tapes, Earphone, and DVD rental information is kept in the system. Flight attendants take tax-free merchandise ordering through hand-held palm PCs. The credit card verification can be accomplished online if the airline needs the service. Flight attendants deliver customs forms to right passengers according to passengers' destinations displayed on the system.

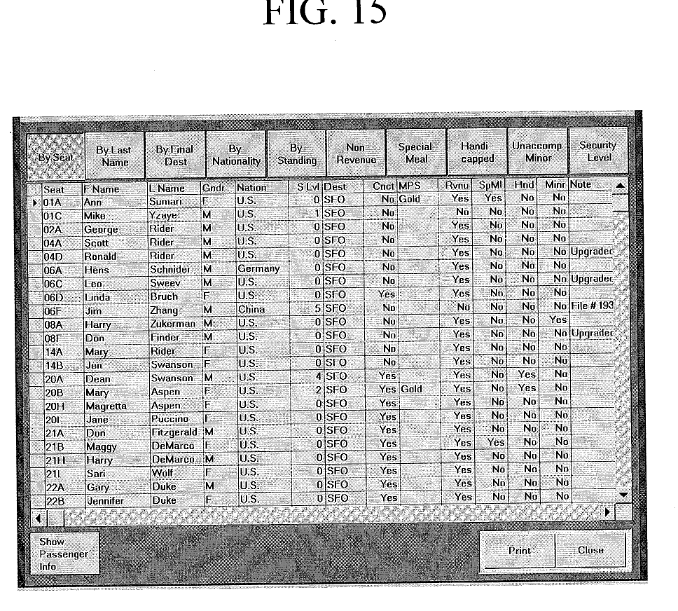

FIG. 14 shows a passenger roster screen that displays all passenger's general information. The roster can be sorted at any selected field.

FIG. 15 shows a screen of seat map with different seat colors representing passengers' various security ranking levels. The passenger roster screen can also be sorted by passengers' security ranking levels. Flight attendants and air marshals pay more attention to passengers with higher security ranking levels.

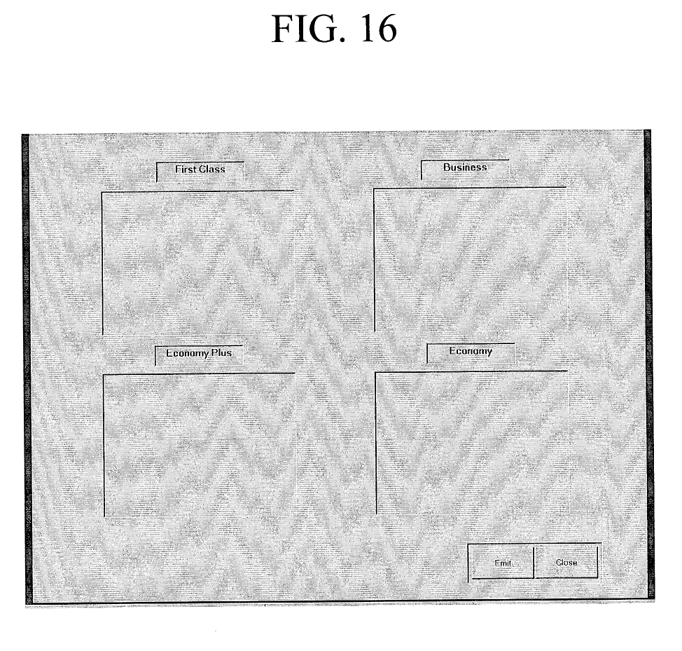

FIG. 16 shows a screen of cabin monitoring and wireless communication. In the cockpit, pilots have a smaller monitoring unit showing the same screen. Flight attendants and air marshals monitor each cabin by using touch screen panel PCs or palm PCs in their hands. The image and sound signals are taken by video cameras and microphones connected to panel PC stations located in different cabins. The emit button on the cabin monitoring screen can be used to establish instant wireless communication between the airplane and headquarters. In case of emergency on the airplane, the pilot presses the emit button to send the cabin image and sound information to airline's and FAA's subsystems. Therefore, these control centers can monitor the situation in airplane cabins in real time. In case of an overall emergency, the airline's and FAA's subsystems can also broadcast detailed information to selected/all airplanes.

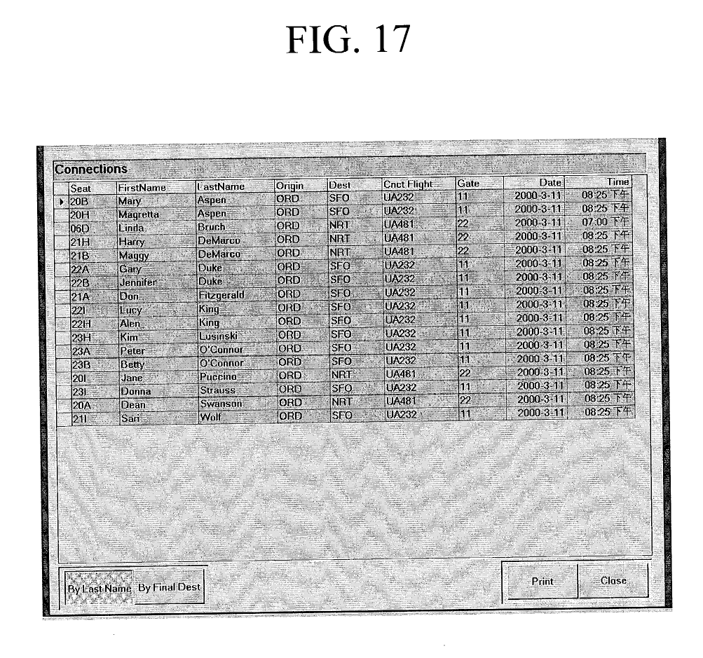

FIG. 17 shows a passenger connection list screen. The screen keeps track of passengers' connection information. Airlines control centers may send real time information of connection to the airplane on-board system through satellite wireless communication. With the help of the airplane on-board system, Flight attendants will greatly improve the quality of personalized services to passengers. For example, personalized connection information as well as luggage information can be announced before the airplane reaches the gate.

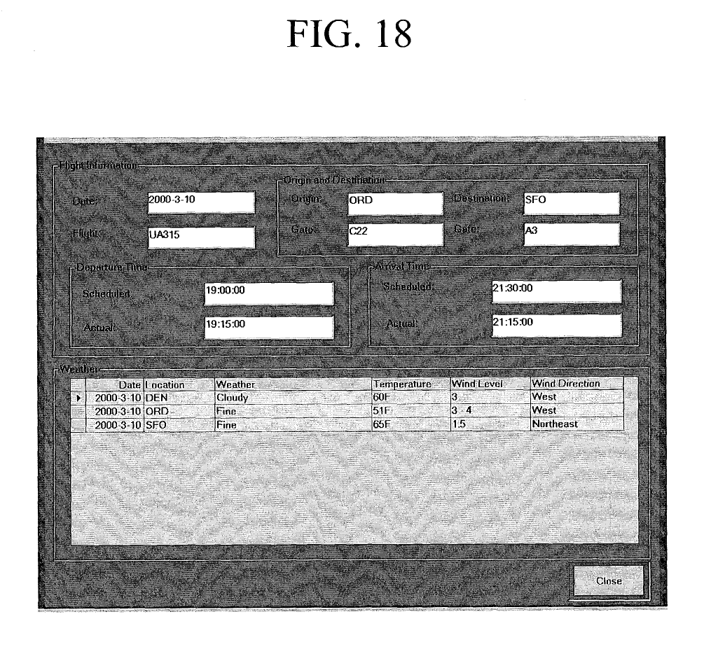

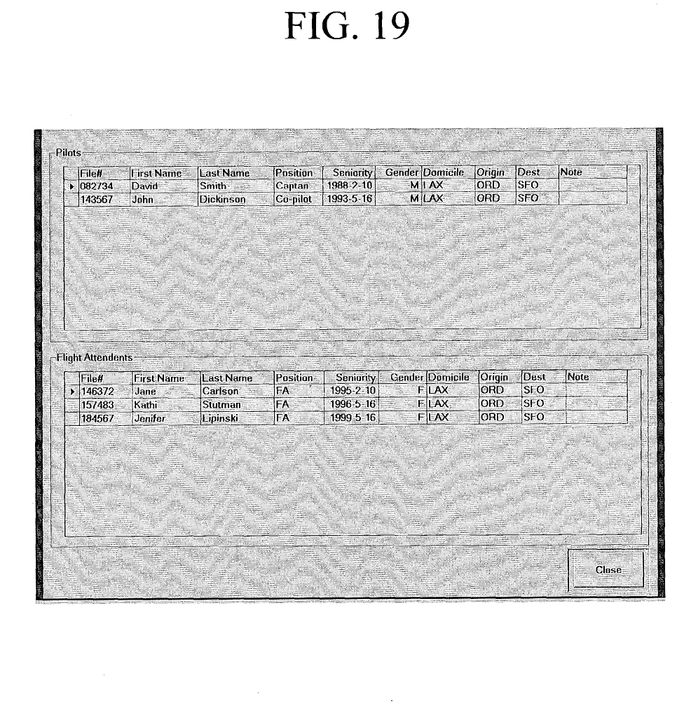

FIG. 18 shows a flight-specific information screen that includes flight schedules and gate information. FIG. 19 shows a pilot and flight attendant information screen. Flight crews will learn the flight and each other a lot easier with the help of the system.

Travel information can also be displayed in a travel information screen. The screen includes Geography information, airport information, and traveler's hot spot information.

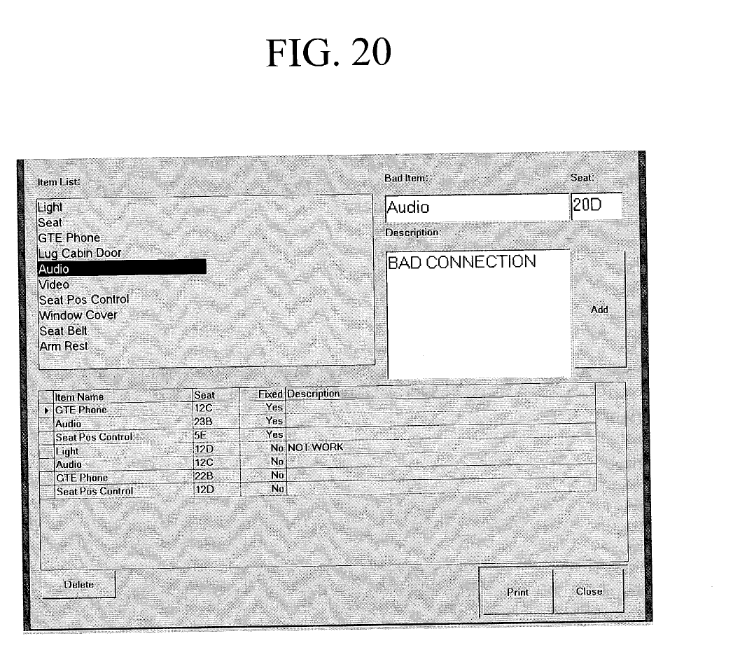

FIG. 20 shows an aircraft maintenance management screen. Aircraft maintenance information is kept by the system. Broken items are recorded after each flight. Repair records are created in the system after problems have been solved. All maintenance records are uploaded to airline's existing maintenance database at certain interval of time.

I claim:

1. An airline security, service, and maintenance management system comprising:
airplane on-board system
airport subsystem
airlines/FAA control center subsystem

2. The system of claim 1 wherein said airplane on-board system comprising:
computer local area network comprising: a plurality of wired touch screen panel PCs installed close to aircraft doors or service areas, a plurality of wireless palm PCs held by air marshals or flight attendants, and a monitoring unit installed in the cockpit for pilots; said computer local area network contains a panel PC as server and the rest as workstations.

3. The system of claim 2 wherein said server contains a passenger record storage means to store a plurality of miscellaneous passenger information records.

4. The system of claim 2 comprising a passenger security level ranking means to evaluate and store the passenger security level ranking information into said server.

5. The system of claim 2 wherein said panel PCs connected to biometrics/smart card reading means, for accepting a passenger into the aircraft door by matching the biometrics information in the smart card boarding pass with the passenger and the flight information in the smart with the flight, and store the passenger's information into said passenger record storage means on said server.

6. The system of claim 2 wherein said panel PCs connected to living image and sound capturing means for monitoring aircraft cabins, and share living image and sound with said other panel PCs, said palm PCs, and said cockpit monitoring unit.

7. The system of claim 2 further comprising:
Telecommunication means connected said server to the telecommunication unit of said airlines or FAA control center subsystem at the request of airplane captain or pilots or at the request of said airlines or FAA control center subsystem.

8. The system of claim 2 further comprising means to provide passenger services including changing seats, supplying foods, selling tax-free merchandises, or giving customs forms, and said server contains a passenger service record storage means to store a plurality of passenger service records.

9. The system of claim 2 further comprising means to maintain aircraft maintenance and service records, and said server contains an aircraft maintenance and service record storage means to store a plurality of aircraft maintenance and service records.

10. The system of claim 1 wherein said airport subsystem comprising:
a check-in counter component integrated into existing airline check-in counter PC, connected with biometrics/smart card writing means, for checking-in passenger, taking passenger's biometrics information and issuing smart card boarding pass that contains passenger's biometrics information and flight information.
a security checking gate component connected with biometrics/smart card reading means, for checking a passenger by matching the biometrics information in said smart card boarding pass with said passenger and said flight information in the smart card with available flights on the boarding gates.

11. The system of claim 9 wherein said check-in counter component can be connected to FBI or CIA's computer system when necessary.

12. The system of claim 1 wherein said airlines FAA control center subsystem comprising:
a telecommunication unit connected to said airplane on-board system through satellite or other communication means at request;
a possible centralized passenger biometrics and security information record storage means.

13. The system of claim 11 wherein said telecommunication unit handles two way communication of real time visual, audio, and other data signals between said telecommunication unit and said airplane computer system.

14. The system of claim 11 wherein said telecommunication unit does not communicate continually with said airplane computer system, and only accept or initiate the communication at request.

15. The system of claim 11 wherein said telecommunication unit can broadcast information to said airplane computer system on selected airplanes.

16. The system of claim 11 wherein said centralized passenger biometrics and security information record storage means can be built or not built depends on passengers' privacy concern.

17. The system of claim 11 wherein said centralized passenger biometrics and security information record storage means can be built or not built depends on passengers' privacy concern.

18 A method of improved passenger reservation, ticking, check-in and boarding, comprising the step of:
accepting passenger's reservations to create a plurality of passenger account records on airline's legacy system, each record including passenger's general information;
issuing passengers tickets, assigning passenger security ranking levels, checking FBI/CAI records if necessary;
handling passengers check in, trying to detect any suspicion, checking FBI/CAI records if necessary, adjusting passenger security ranking levels if necessary, taking passengers' biometrics information, issuing smart card that containing passengers' biometrics, general and flight information, and creating a plurality of passenger check-in records on airline's legacy system;
allowing passengers boarding, checking smart card's biometrics information with passengers, check smart card's flight information with the flight; creating a plurality of passenger records on said server on airplane; comparing all boarding records with check-in information from front counter to decide a departure.
